(19) United States
(12) Patent Application Publication
(10) Pub. No.: US 2025/0193041 A1
(43) Pub. Date: Jun. 12, 2025

(54) SERVER DEVICE, HOME APPLIANCE MANAGEMENT SYSTEM, AND SERVER DEVICE CONTROL METHOD

(71) Applicant: SAMSUNG ELECTRONICS CO., LTD., Suwon-si (KR)

(72) Inventors: Jiwon HAN, Suwon-si (KR); Jeongmun YEOM, Suwon-si (KR)

(73) Assignee: SAMSUNG ELECTRONICS CO., LTD., Suwon-si (KR)

(21) Appl. No.: 19/062,195

(22) Filed: Feb. 25, 2025

Related U.S. Application Data
(63) Continuation of application No. PCT/KR2023/010389, filed on Jul. 19, 2023.

(30) Foreign Application Priority Data
Sep. 13, 2022 (KR) 10-2022-0115237

(51) Int. Cl. H04L 12/28; G06F 3/04842; G06T 11/00

(52) U.S. Cl. CPC H04L 12/282; G06F 3/04842; G06T 11/00

(57) ABSTRACT

A server device comprising a communication circuitry to receive user interface information from a controller of a home appliance, and transmitting the user interface information to a user terminal device; and a processor to convert the user interface information into an image based on a user input received from the user terminal device, and control the communication circuitry to transmit the image to the controller of the home appliance.

### CROSS-REFERENCE TO RELATED APPLICATION

This application is a continuation application is a continuation application, under 35 U.S.C. § 111(a), of international application No. PCT/KR2023/010389, filed Jul. 19, 2023, which claims priority under 35 U. S. C. § 119 to Korean Patent Application No. 10-2022-0115237, filed Sep. 13, 2022, the disclosures of which are incorporated herein by reference in their entireties.

### TECHNICAL FIELD

The present disclosure relates to a server device, a home appliance management system, and a server device control method that are capable of controlling a home appliance connected via home networking.

### BACKGROUND ART

Recently, there has been an increasing demand for monitoring and controlling various home appliances through a controller in the home.

Accordingly, a controller for controlling a plurality of home appliances is equipped with a display and an input device to select a home appliance to be controlled and control the selected home appliance.

However, when the controller for controlling home appliances does not have a separate keypad, the names of home appliances may not be changed on the controller, which may cause inconvenience to the user in selecting a home appliance to be controlled.

### DISCLOSURE

### Technical Problem

According to an embodiment, a home appliance management system in which a user interface provided by a controller is transmitted to a user terminal device, and the name of a home appliance is changed on the user terminal device is provided.

According to an embodiment, a server device control method, capable of, based on a user input to change the name of a home appliance being received from a user terminal device, converting the user input into an image and transmitting the image to a controller, and providing a user interface for changing the name of a home appliance using the received image by the controller is provided.

### Technical Solution

A server device according to an embodiment includes: a communication circuitry configured to receive user interface information from a controller of a home appliance and transmit the user interface information to a user terminal device; and a processor configured to convert the user interface information into an image based on a user input received from the user terminal device, and control the communication circuitry to transmit the image to the controller of the home appliance.

The user input may include a text input enabling text in the user interface information to be changed.

The processor may be configured to convert information about changed text into a bitmap image.

The processor may be configured to divide the bitmap image into syllable units to generate at least one object.

The processor may be configured to control the communication circuitry to transmit the at least one object to the controller.

A home appliance management system according to an embodiment includes: a controller configured to control a home appliance; a user terminal device configured to receive a user input; and a server device configured to communicate with the controller and the user terminal device, wherein the server device is configured to convert user interface information into an image based on the user input received which is from the user terminal device, and control a communication circuitry to transmit the image to the controller.

The user terminal device may be configured to display an input screen configured to receive changes inputted to the user interface information from the user.

The user terminal device may display changes inputted in an input screen to be overlaid on the user interface information that may be a target of the change.

The controller may be configured to display an input screen configured to receive a selection in association with the image from a user.

The controller may be configured to, based on an image displayed on the input screen according to the selection by the user, change text information in the user interface information.

A service device control method according to an embodiment includes: receiving user interface information from a controller; transmitting the user interface information to a user terminal device; converting the user interface information into an image based on an user input received from the user terminal device; and transmitting the image to the controller.

The user input may include a user input to change text information in the user interface information.

The service device control method may further include converting the changed text information into a bitmap image.

The service device control method may further include dividing the bitmap image into syllable units to generate at least one object.

The service device control method may further include transmitting the at least one object to the controller.

### Advantageous Effects

According to an embodiment, a server device, a home appliance management system, and a server device control method can allow multilingual input on a controller, which is not equipped with a character keypad, through transmission of an image, and can expand the range of limited expressions by reusing the transmitted image.

### DESCRIPTION OF DRAWINGS

FIG. 1 is a schematic diagram showing communication between a server device, a controller, and a user terminal device according to an embodiment.

FIG. 2 is a diagram showing a controller controlling a plurality of home appliances according to an embodiment.

FIG. 3 is a control block diagram of a server device according to an embodiment.

FIG. 4 is a diagram showing transmission of user interface information from a controller to a user terminal device according to an embodiment.

FIG. 5 is a diagram showing a user terminal device changing user interface information and transmitting the changed user interface to a controller according to an embodiment.

FIG. 6 is a diagram showing objects that are selectable by a user on a controller according to an embodiment.

FIG. 7 is a diagram showing the result of changing the names of a plurality of home appliances on a controller according to an embodiment.

FIG. 8 is a control flowchart of a home appliance management system according to an embodiment.

FIG. 9 is a control flowchart of a user terminal according to an embodiment.

FIG. 10 is a control flowchart of a controller according to an embodiment.

### MODES OF THE INVENTION

The embodiments described in the disclosure and the configurations shown in the drawings are only examples of the disclosure, and various modifications may be made at the time of filing of the disclosure to replace the embodiments and drawings of the disclosure.

In the description of the drawings, like numbers refer to like elements throughout the description of the drawings.

The terms used herein are for the purpose of describing the embodiments and are not intended to restrict and/or to limit the disclosure. The singular expressions herein may include plural expressions, unless the context clearly dictates otherwise. In addition, the terms “comprises”, “includes”, and “has” are intended to indicate that there are features, numbers, steps, operations, elements, parts, or combinations thereof described in the disclosure, and do not exclude the presence or addition of one or more other features, numbers, steps, operations, elements, parts, or combinations thereof.

It will be understood that, although the terms first, second, etc. used in the disclosure may be used herein to describe various components, these components should not be limited by these terms. These terms are only used to distinguish one component from another. For example, a first element could be termed a second element, and similarly, a second element could be termed a first element without departing from the scope of the disclosure. The term “and/or” includes combinations of one or all of a plurality of associated listed items.

The terms, such as “˜ part”, “˜device”, “˜block”, “˜member”, “˜ module”, and the like may refer to a unit for processing at least one function or act. For example, the terms may refer to at least process processed by at least one hardware, such as a field-programmable gate array (FPGA) and/or application specific integrated circuit (ASIC), software stored in memories, or processors.

In each step, an identification symbol is used to refer to each step, the identification symbol does not limit the order of each step, and each step may be performed in an order different from the described order unless the context clearly indicates a specific order.

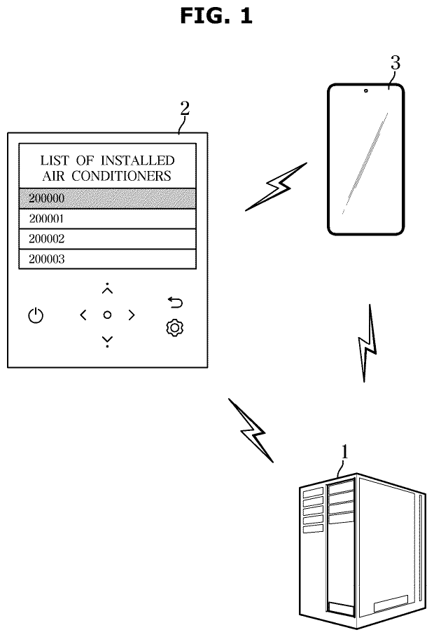

FIG. 1 is a schematic diagram showing communication between a server device, a controller, and a user terminal device according to an embodiment.

Referring to FIG. 1, a server device 1 may communicate with a controller 2 and/or a user terminal device 3 through communication circuitry 20. For example, the controller 2 may communicate with the user terminal device 3 via the server device 1.

The server device 1 may establish wireless communication with the controller 2 and/or the user terminal device 3 to perform communication, and as described below, may communicate with each other through various known wireless communication standards, such as Wifi, LTE, 3GPP, LAN, and Ethernet.

The server device 1 may, based on the established communication method, receive information transmitted from the controller 2 and transmit the information to the user terminal device 3, and may process information transmitted from the user terminal device 3 and transmit the processed information to the controller 2.

The server device 1 may include a co-location server, a server hosting, and a cloud server.

The server device 1 may include a control program, a non-volatile memory 12 in which the control program is installed, a volatile memory 12 in which at least a part of the installed control program is loaded, and at least one processor 11 or a central processing unit (CPU) configured to execute the loaded control program.

The control program may include a program implemented in the form of at least one of a BIOS, a device driver, an operating system, firmware, a platform, and an application program.

As an example, the application program may be installed or stored in advance in a server when the server is manufactured, or may be installed in a server based on received data of an application program data that is received from an external source later during use.

The controller 2 may include a remote controller 2 for controlling an electronic device including a home appliance.

The controller 2 is a remote control device that transmits control commands to control the operation of home appliances, and may include a cellphone (PCS phone), a smart phone, a personal digital assistant (PDA), a portable multimedia player (PMP), a laptop computer, a digital broadcasting terminal, a netbook, a tablet PC, a navigation device, and the like, but the following description is made based on a wired remote controller without a character keypad as an example of the controller 2.

The user terminal device 3 may include at least one of a smartphone, a tablet personal computer (PC), a mobile phone, a video phone, an e-book reader, a desktop personal computer (PC), a laptop personal computer (PC), a netbook computer, a personal digital assistant (PDA), a portable multimedia player (PMP), an MP3 player, a mobile medical device, a camera, or a wearable device (e.g., a head-mounted device (HMD), such as electronic glasses, electronic clothing, an electronic bracelet, an electronic necklace, an electronic accessory, an electronic tattoo, or a smart watch).

In addition, the user terminal device 3 according to various embodiments of the present disclosure may be a flexible device. In addition, it should be understood to those skilled in the art that the user terminal device 3 according to various embodiments of the present disclosure is not limited to the above-described devices.

The user terminal device 3 may receive a user's command, and specifically, may receive text for changing user interface (UI) information. In this case, the text for changing the user interface information may include multilingual characters and may further include numbers and special characters.

The server device 1 according to an embodiment may provide a home appliance management system that enables change to the user interface even on the controller 2 that does not have a character keypad by communicating with the controller 2 and the user terminal device 3.

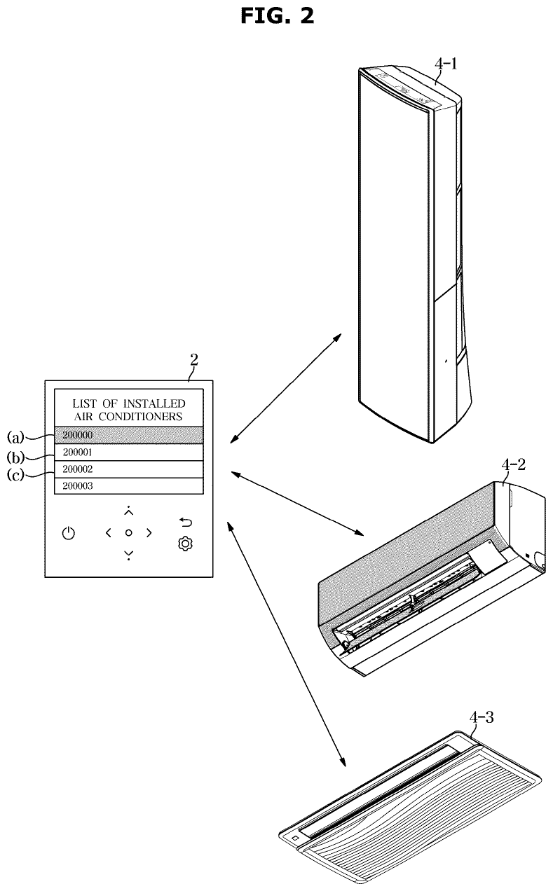

FIG. 2 is a diagram showing a process of a controller controlling a plurality of home appliances according to an embodiment.

The controller 2 may control a plurality of home appliances in an integrated manner, and as shown in FIG. 2, may display each home appliance with a preset product code. For example, the controller 2 may control a plurality of air conditioners installed in different areas, and a stand-alone air conditioner 4-1 may be indicated as “200000” as (a) in FIG. 2, a wall-mounted air conditioner 4-2 may be indicated as “200001” as in (b) in FIG. 2, and a ceiling-type air conditioner 4-3 may be indicated as “200002” as in (c) in FIG. 2.

In this case, the stand-alone air conditioner 4-1, the wall-mounted air conditioner 4-2, and the ceiling-type air conditioner 4-3 may be installed in different areas, and electronic devices that may be controlled by the controller 2 are not limited to air conditioners but may include all home appliances.

Specifically, the home appliance controlled by the controller 2 may be a smart home appliance. The smart home appliances may include, for example, at least one of a television, a digital video disk (DVD) player, an audio device, a refrigerator, an air conditioner, a vacuum cleaner, an oven, a microwave oven, a washing machine, an air purifier, a set-top box, a TV box, a game console, an electronic dictionary, an electronic key, a camcorder, or an electronic picture frame.

The controller 2 may transmit a control signal for controlling the operation of each of the air conditioners 4-1, 4-2, and 4-3, and specifically, the controller 2 may transmit, to each of the air conditioners 4-1, 4-2, and 4-3, control signals for turning on/off the power, changing the set temperature, changing the wind direction, setting a reservation, and switching modes of the air conditioner 4-1, 4-2, and 4-3.

In this case, the user may manipulate the controller 2 to control the air conditioner installed in a specific area. Specifically, the user may operate a manipulating portion of the controller 2 to select the product code of the air conditioner 4-1, 4-2, or 4-3 displayed on the controller 2. The manipulating portion of the controller 2 may include a power button, an operation button, a function selection dial, and a detailed setting button. In addition, the controller 2 may be provided as a tact switch, a push switch, a slide switch, a toggle switch, a micro switch, or a touch switch.

The user may select one of the a plurality of air conditioners 4-1, 4-2, and 4-3 by manipulating an interface of the controller 2, but the controller 2 that does not have a character keypad may display the list of installed air conditioners as product codes. Accordingly, it may be difficult for the user to intuitively identify the installation location by looking at the product codes of each air conditioner 4-1, 4-2, and 4-3.

However, the server device 1 according to an embodiment may change user interface information of the controller 2 on the user terminal device 3 equipped with a character keypad to, and may change user interface information even on the controller 2 by converting the user interface information into an image, thereby enhancing user convenience.

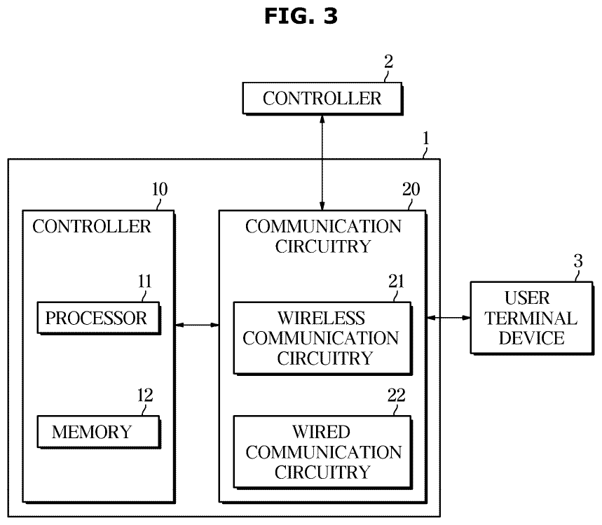

FIG. 3 is a control block diagram of a server device according to an embodiment.

Referring to FIG. 3, a server device 1 according to an embodiment may include a controller 10 and communication circuitry 20.

Specifically, the server device 1 may include a communication circuitry 20 for communicating with a controller 2 and a user terminal device 3 and a controller 10 for controlling the communication circuitry 20.

The communication circuitry 20 may transmit data to an external device or receive data from an external device based on the control of the controller 10. For example, the communication circuitry 20 may communicate with the controller 2 and/or the user terminal device 3 to transmit and receive various types of data.

To this end, the communication circuitry 20 may support establishment of a direct (e.g., wired) communication channel or a wireless communication channel with external electronic devices (e.g., the controller 2 and/or the user terminal device 3), and performance of communication through the established communication channel.

According to an embodiment, the communication circuitry 20 may include wireless communication circuitry 21 (e.g., a cellular communication module, a short-range wireless communication module, or a global navigation satellite system (GNSS) communication module) or wired communication circuitry 22 (e.g., a local area network (LAN) communication module, or a power line communication module).

A corresponding communication module among the communication modules may communicate with an external electronic device via a first network (e.g., a short-range communication network, such as Bluetooth, wireless fidelity (WiFi) direct, or infrared data association (IrDA)) or a second network (e.g., a long-range communication network, such as a legacy cellular network, a 5G network, a next-generation communication network, the Internet, or a computer network (e.g., a LAN or WAN)). These various types of communication modules may be integrated into a single component (e.g., a single chip) or implemented as a plurality of separate components (e.g., a plurality of chips).

According to various embodiments, the communication circuitry 20 may establish communication with the controller 2 and the user terminal device 3 and serve as a medium for information transmission.

In various embodiments, the communication circuitry 20 may include a Wi-Fi module and may perform communication with the controller 2 and/or the user terminal device 3 based on establishment of communication with an access point (AP) in the home.

The controller 10 may include a processor 11 that generates a control signal regarding the operation of the image output device, and a memory 12 that stores a program, application, instruction, and/or data for the operation of the image output device. The processor 11 and the memory 12 may be implemented as separate semiconductor devices or may be implemented as a single semiconductor device. In addition, the controller 10 may include a plurality of processors 11 or a plurality of memories 12.

The processor 11 may include a calculation circuit, a memory circuit, and a control circuit. The processor 11 may include a single chip or a plurality of chips. In addition, the processor 11 may include a single core or a plurality of cores.

The memory 12 may store a program for controlling the server device 1 according to user commands and data including settings based on input values. In addition, the memory 12 may store data received from the controller 2 and the user terminal device 3.

The memory 12 may include volatile memory, such as static random access memory (S-RAM) and dynamic random access memory (D-RAM), and nonvolatile memory, such as read only memory (ROM), and erasable programmable read only memory (EPROM). The memory 12 may include a single memory element or a plurality of memory elements.

The processor 11 may process data and/or signals using a program provided from the memory 12, and transmit a control signal to each component of the server device 1 based on the processing result. For example, the processor 11 may process a user input received through the controller 2 and the user terminal device 3, and the processor 11 may control the communication circuitry 20 to transmit user interface information received from the controller 2 to the user terminal device 3.

As another example, the processor 11 may convert a user interface changed based on a user input received from the user terminal device 3 into an image using a program provided from the memory 12.

As another example, the processor 11 may divide the converted image to generate at least one object.

As another example, the processor 11 may control the communication circuitry 20 to transmit the generated object to the controller 2 of the home appliance.

According to the present disclosure, even when the controller 2 controlling the home appliance does not have a character keypad, home appliances may be named through the user terminal device 3 and the result may be utilized on the controller 2, thereby increasing convenience.

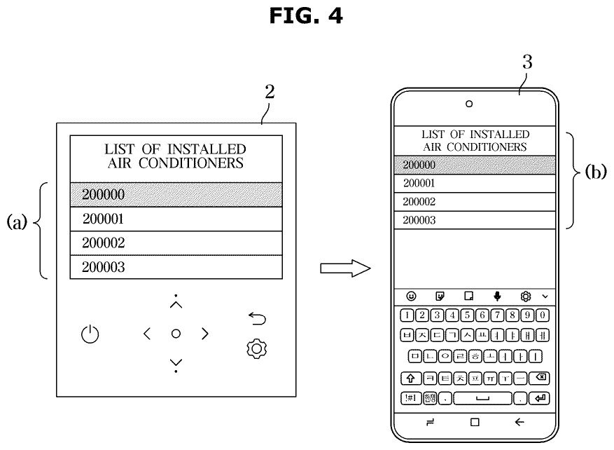

FIG. 4 is a diagram showing a process in which user interface information is transmitted from a controller to a user terminal device according to an embodiment.

Referring to FIG. 4, the controller 2 may transmit user interface information (a) to the user terminal device 3.

Specifically, the controller 2 may transmit user interface information to the user terminal device 3 through the server device 1, and the controller 2 may transmit the user interface information to the user terminal device 3 through direct communication.

The user interface information may include information about one or more home appliances, a registration order of the home appliances, and text information corresponding to the names of the home appliances. For example, a display of the controller 2 may display preset product codes of each air conditioner as user interface information under an item “Installed Air Conditioner List.”

The user terminal device 3 may receive user interface information directly from the controller 2 or indirectly from the server device 1. The user terminal device 3 may display a user interface b that is identical to a user interface displayed on the display of the controller 2.

To this end, the user terminal device 3 may display the user interface by installing an integrated application. The integrated application may be an application program that may manage and control home appliances in an integrated manner.

The user terminal device 3 may execute the integrated application and display the user interface (b) identical to that of the controller 2 on the integrated application based on the user interface information received from the controller 2 or the server device 1.

Accordingly, the user may be provided with the user interface (b), which is identical to the user interface (a) displayed on the controller 2, on the user terminal device 3. That is, since the user may edit the user interface (b), which is identical to the user interface (a) manipulated on the controller 2, on the user terminal device 3, there is an effect of allowing multilingual expression using the keypad of the user terminal device 3.

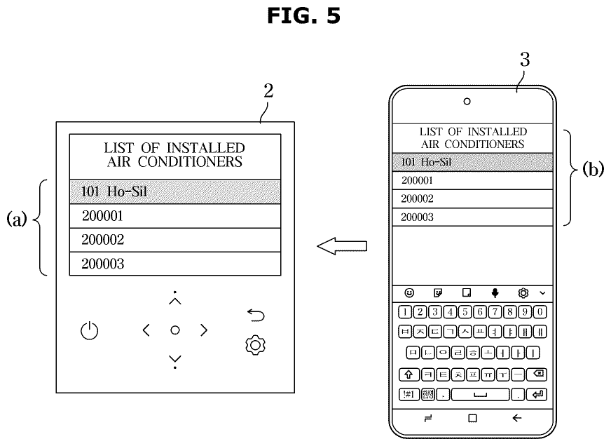

FIG. 5 is a diagram showing a user terminal device changing user interface information and transmitting the changed user interface to a controller according to an embodiment.

Referring to FIG. 5, the user may change information of the user interface b using the keypad of the user terminal device 3. Specifically, the user may select an air conditioner for which the user desires to change the name and change the name of the selected air conditioner by typing on the keypad at the bottom of the user terminal device 3.

In this case, since the keypad of the user terminal device 3 includes not only numbers but also a plurality of languages, such as Korean and English, special characters, spaces, etc., the user terminal device 3 may change the name of the home appliance in various methods.

For example, as shown in FIG. 5, the name of the first air conditioner may be changed to “101Ho-Sil.” That is, when a plurality of air conditioners are installed in different rooms, such as Room 101, Room 102, Room 103, and Room 104, and the controller 2 is provided in a separate space, the user may control the air conditioners of all the rooms using the names of the air conditioners displayed on the controller 2.

Thereafter, the user terminal device 3 may transmit a text input received from the user to the server device 1. The server device 1 may apply the received text input to change the user interface information (a), and may convert the changed user interface information (b) into a bitmap image and transmit the bitmap to the controller 2.

Accordingly, the controller 2 may receive the changed user interface information (a) and display the changed user interface information (a) on the display.

As a result, as shown in FIG. 5, the user interface information (a) changed on the user terminal device 3 is displayed on the controller 2, enabling the user to identify the air conditioner name as “101Ho-Sil” instead of “200000”.

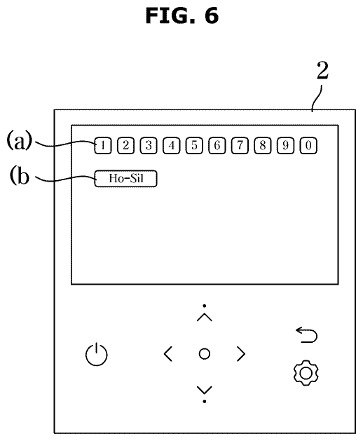

However, when the changed user interface image itself is transmitted to the controller 2 as shown in FIG. 5, communication with the user terminal device 3 may be required again when there is a need for additional changes. Therefore, a method of resolving such a limitation is described with reference to FIG. 6.

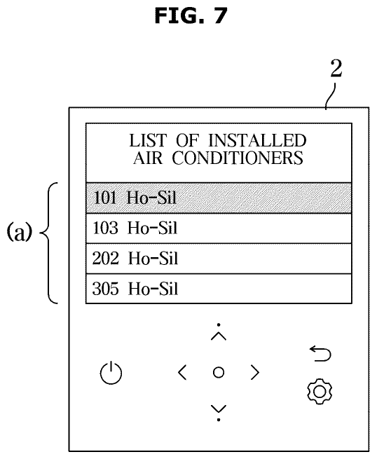

FIG. 6 is a diagram showing objects that are selectable by a user on a controller according to an embodiment. FIG. 7 is a diagram showing the result of changing the names of a plurality of home appliances on a controller according to an embodiment.

Referring to FIG. 6, the server device 1 may divide the converted user interface image into at least one object a and b. Thereafter, the server device 1 may transmit the divided objects a and b to the controller 2.

The controller 2 may separately display the divided objects a and b on the display such that the objects a and b are selected by the user. That is, the controller 2 may display a number object (a) and a character object (b), which are divided images, on the display as shown in FIG. 6, allowing the user to select the objects a and b. Thereafter, the controller 2 may change the names of the home appliances based on an object being selected by the user.

To this end, the server device 1 may receive an input to change the name of the home appliance from the user terminal device 3, and may change text information in the user interface information based on the received input. Thereafter, the server device 1 may convert the changed text information into a bitmap image, divide the bitmap image into syllable units (i.e., in character units), thereby generating at least one object.

For example, as shown in FIG. 5, the server device 1 may receive “101 Ho-Sil (Room 101)” as an user input to change user interface information. The server device 1 may divide “101 Ho-Sil (Room 101)” into syllable units (i.e., in character units) such as “1”, “0”, “1”, “Ho”, and “Sil” to generate objects. In this case, the server device 1 may store “1”, “0”, “Ho”, and “Sil” as objects, excluding duplications.

As another example, the server device 1 may receive “202 Ho, Cheolsu-Bang (Room 202, Cheolsu's room)” as an user input to change user interface information. The server device 1 may divide “202 Ho, Cheolsu-Bang” into syllable units (i.e., in character units), such as “2”, “0”, “2”, “Ho”, “Cheol”, “Su”, and “Bang” to generate objects. In this case, the server device 1 may store “2”, “0”, “Ho”, “Cheol”, “Su”, and “Bang” as objects, excluding duplications.

After that, the server device 1 may transmit the generated objects to the controller 2.

The controller 2 may receive the objects and display the received objects on the display to provide the user with a user interface. Specifically, the controller 2 may display the received plurality of objects such that the received plurality of objects may be selected one by one, and as shown in FIG. 6, the number objects (denoted as (a)) from 0 to 9 and the character object (denoted as (b)) of “Ho-Sil” may be displayed on the display to guide user's selection.

After that, the user may change the name of the home appliance by selecting the displayed objects one by one. For example, when the number objects (denoted as (a)) “3”, “0”, and “3” are selected in order and “Ho-Sil” is selected, the name of the selected home appliance may be changed to “303 Ho-Sil”.

As another example, when the objects generated by the server device 1 are “Ae”, “Eo”, “Keon”, “1”, the user may change the name of the home appliance by selecting “Ae”, “Eo”, “Keon” displayed on the controller 2 in order and changing only the following number. In other words, the user may select “Ae”, “Eo”, “Keon” displayed on the controller 2 in order and then select the number “2”, thereby setting the name of the air conditioner “Air Conditioner 2” different from “Air Conditioner 1”.

The home appliance management system according to an embodiment has a benefit that, upon receiving words frequently used in the names of home appliances, such as “Ho-Sil” or “Ae-Eo-Keon” only once through the user terminal device 3, convert the words into objects and allow the words to be continuously utilized by the controller 2.

Referring to FIG. 7, FIG. 7 shows the result of changing the names of the home appliances based on an object being selected by the user.

The controller 2 may, in response to an air conditioner for which the name is to be changed, and objects shown in FIG. 6 being selected by the user, change the name of the air conditioner, and display the changed name as a user interface (a).

In the user interfaces (a), “101 Ho-Sil (Room 101)” is a text input received from the server device 1 as shown in FIGS. 5, and “103 Ho-Sil (Room 103)”, “202 Ho-Sil (Room 202)”, and “305 Ho-Sil (Room 305)” are names of air conditioners changed as the user selects the objects displayed on the controller 2.

That is, the server device 1 may receive the text input of “101 Ho-Sil (Room 101)” from the user terminal device 3, convert the text input into an image, and divide the image to generate “1”, “0”, “Ho”, and “Sil” as objects. Thereafter, the server device 1 may transmit the generated objects to the controller 2.

The controller 2 may receive the objects and display the objects on the display as shown in FIG. 6.

The user may change the name of an air conditioner for which the name has not been changed in the air conditioner list displayed on the controller 2 using the manipulation buttons of the controller 2. Specifically, the user may sequentially select “1”, “0”, “3”, “Ho”, and “Sil” among the objects displayed on the controller 2 to change the air conditioner name corresponding to “200001” shown in FIG. 5, the user may sequentially select “2”, “0”, “2”, “Ho”, and “Sil” among the objects displayed on the controller 2 to change the air conditioner name corresponding to “200002” shown in FIG. 5, and the user may sequentially select “3”, “0”, “5”, “Ho”, and “Sil” among the objects displayed on the controller 2 to change the air conditioner name corresponding to “200003” shown in FIG. 5.

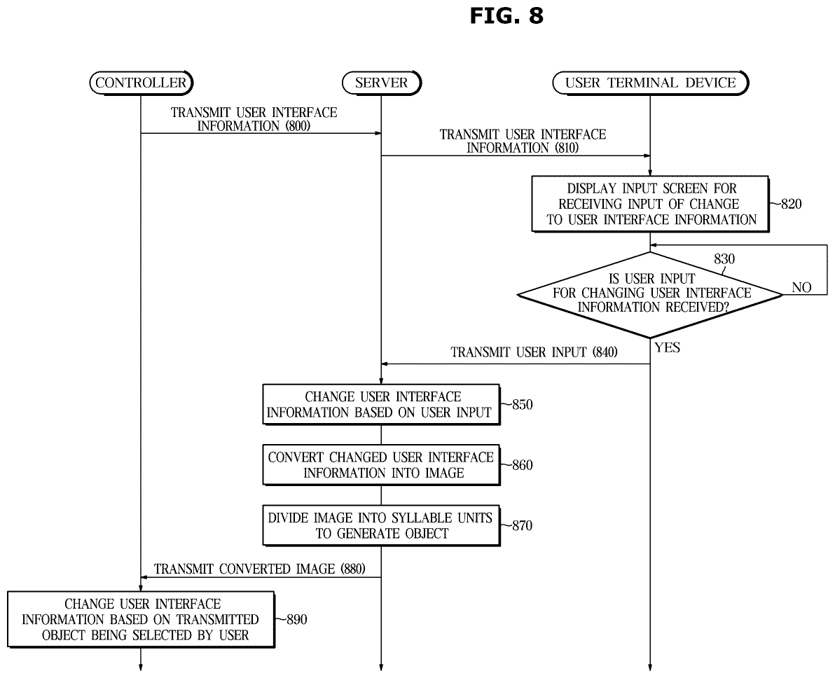

FIG. 8 is a control flowchart of a home appliance management system according to an embodiment.

Referring to FIG. 8, the server device 1 may establish a home appliance management system by establishing communication with a controller 2 and a user terminal device 3.

Specifically, the controller 2 may transmit user interface information including the names of the home appliances to the server (800). In this case, the user interface information transmitted by the controller 2 may include the names of the home appliances, such as a code name or serial number that are difficult for the user to distinguish between a plurality of air conditioners.

Thereafter, the server device 1 may transmit the user interface information received from the controller 2 to the user terminal device 3 (810). That is, the server device 1 may transmit the user interface information which is the same as that displayed on the controller 2 to the user terminal device 3 such that the user may change the user interface information through the user terminal device 3 equipped with a keypad.

The user terminal device 3 may display the same user interface as the user interface displayed on the controller 2 and display an input screen for receiving an input of changes to the user interface information (820). In this case, the input screen may include a text box for displaying a text input of the user.

Thereafter, the user terminal device 3 may identify whether a user input for changing the user interface information has been received (830). When the user input for changing the user interface information is received (YES in operation 830), the user terminal device 3 may transmit the user input to the server device 1 (840).

The server device 1 may receive the user input for changing the user interface information from the user terminal device 3 and change the user interface information based on the user input (850). In this case, the user interface information changed by the server device 1 may include text information regarding the names of the home appliances.

The server device 1 may change the user interface information and convert the changed user interface information into an image (860). Thereafter, the server device 1 may divide the converted image into syllable units (i.e., in character units) to generate at least one object (870).

The server device 1 may transmit the converted image (880), and the converted image may include at least one object, which is the image divided into syllable units (i.e., in character units).

The controller 2 may receive the at least one object, display the at least one object on the display such that the user may select the object, and based on the object being selected by the user, change the user interface information.

That is, as described above, the user may change the name of the home appliance by selecting at least one object displayed on the controller 2.

Accordingly, the home appliance management system according to an embodiment may change the name of the home appliance to a name desired by the user even on the controller 2 that does not have a character keypad, thereby enhancing the efficiency of home appliance management.

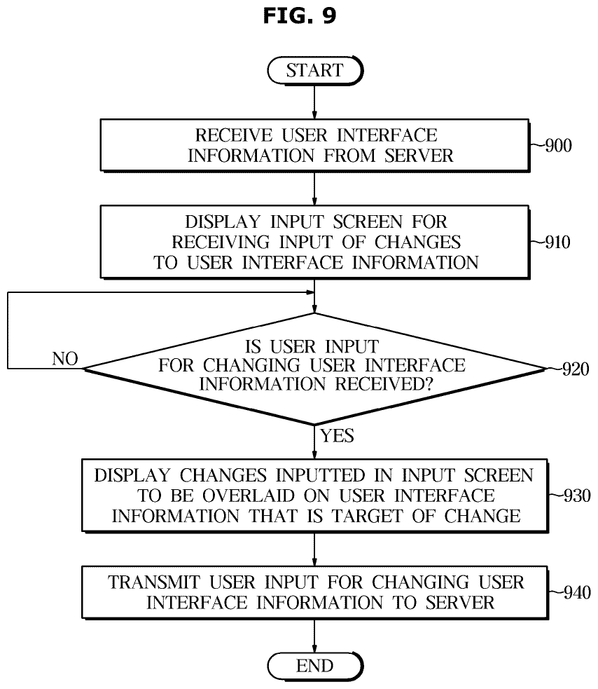

FIG. 9 is a control flowchart of a user terminal according to an embodiment.

Referring to FIG. 9, the user terminal device 3 may receive user interface information from the server (900). The user interface information may be the same as user interface information displayed on the controller 2 and may include the names of the home appliances.

The user terminal device 3 may display an input screen for receiving an input of changes to the user interface information (910). That is, the user terminal device 3 may display an input window including a cursor for receiving a text input for changing the name of a home appliance.

Thereafter, the user terminal device 3 may identify whether a user input for changing the user interface information has been received (920). Upon receiving the input for changing the user interface information (YES in operation 920), the user terminal device 3 may display the changes inputted in the input screen to be overlaid on the user interface information that is the target of the change (930).

For example, when the name of the home appliance received from the server device 1 is “200000” and the name of the home appliance inputted from the user is “101 Ho-Sil”, the user interface may be displayed such that the text indicator of “200000” is hidden by “101 Ho-Sil”. Accordingly, the user may identify that the text indicator of “200000” has been changed to “101 Ho-Sil”.

Afterwards, the user terminal device 3 may transmit the user input for changing the user interface information to the server device 1 (940).

The home appliance management system management according to an embodiment has been described as the server device 1 changing the user interface information and generating objects as shown in FIG. 8. However, when the user terminal device 3 is provided with a separate processor 11 and a separate memory 12, the user terminal device 3 may also change the user interface information and generate objects. That is, the controller 2 may receive objects for changing the user interface information through direct communication between the user terminal device 3 and the controller 2.

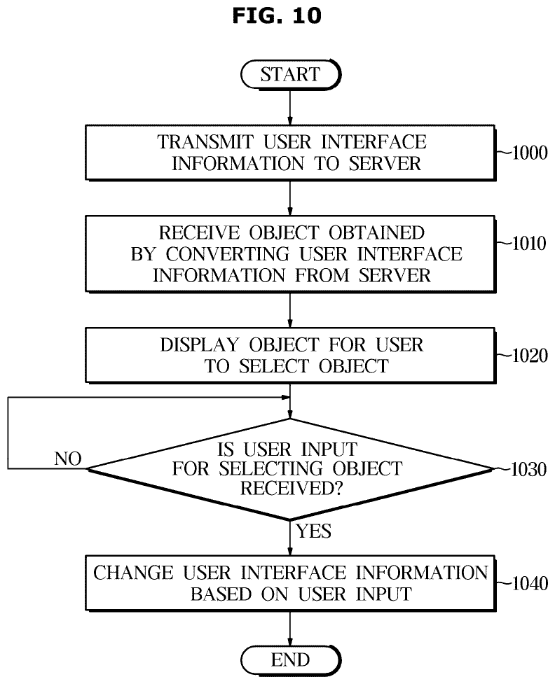

FIG. 10 is a control flowchart of a controller according to an embodiment.

Referring to FIG. 10, the controller 2 may transmit user interface information to a server (1000). Here, the user interface information may be the same as the user interface information transmitted to the user terminal device 3 through the server device 1.

Thereafter, the controller 2 may receive objects obtained by converting the user interface information from the server (1010). The object received by the controller 2 may be an image obtained by converting the user interface information, which is changed by the user, into an image and then dividing the converted image.

The controller 2 may display the objects on the display such that the user may select the received object (1020). In this case, the objects displayed on the display may be images obtained by dividing the user input into syllable units (i.e., in character units) and removing duplicates.

The controller 2 may identify whether a user input for selecting the object displayed on the display has been received (1030). That is, the user may select the object by touching the display of the controller 2 or manipulating the manipulation button provided on the display.

The controller 2 may change the user interface information based on the user input for selecting the object (1040). Specifically, the user may select the name of a home appliance that is the target of change in the user interface information, and sequentially select the objects displayed on the display, so that the name of the home appliance may be changed.

Accordingly, the home appliance management system according to an embodiment may, even when the controller 2 is not equipped with a keypad and thus unable to input multilingual or special characters, receive an input of multilingual or special characters from the user terminal device 3 and change the name of the home appliance directly on the controller 2, thereby enhancing the convenience of home appliance management for the user.

Meanwhile, the disclosed embodiments may be embodied in the form of a recording medium storing instructions executable by a computer. The instructions may be stored in the form of program code and, when executed by a processor, may generate a program module to perform the operations of the disclosed embodiments. The recording medium may be embodied as a computer-readable recording medium.

The computer-readable recording medium includes all kinds of recording media in which instructions which may be decoded by a computer are stored, for example, a Read Only Memory (ROM), a Random Access Memory (RAM), a magnetic tape, a magnetic disk, a flash memory, an optical data storage device, and the like.

The computer-readable recording medium may be provided in the form of a non-transitory storage medium. Here, when a storage medium is referred to as “non-transitory,” it can be understood that the storage medium is tangible and does not include a signal (electromagnetic waves), but rather that data is semi-permanently or temporarily stored in the storage medium. For example, a ‘non-temporary storage medium’ may include a buffer in which data is temporarily stored.

According to one embodiment, the methods according to the various embodiments disclosed herein may be provided in a computer program product. The computer program product may be traded between a seller and a buyer as a product. The computer program product may be distributed in the form of a machine-readable storage medium (e.g., compact disc read only memory (CD-ROM)), or may be distributed through an application store (e.g., Play Store™) online. In the case of online distribution, at least a portion of the computer program product may be stored at least semi-permanently or may be temporarily generated in a storage medium, such as a memory of a server of a manufacturer, a server of an application store, or a relay server.

Although embodiments of the present disclosure have been described with reference to the accompanying drawings, those skilled in the art will appreciate that these inventive concepts may be embodied in different forms without departing from the scope and spirit of the disclosure, and should not be construed as limited to the embodiments set forth herein.

1. A server device comprising:
a communication circuitry configured to receive user interface information from a controller of a home appliance and transmit the user interface information to a user terminal device; and
a processor configured to convert the user interface information into an image based on a user input received from the user terminal device, and control the communication circuitry to transmit the image to the controller of the home appliance.

2. The server device of claim 1, wherein the user input is a text input enabling text in the user interface information to be changed.

3. The server device of claim 2, wherein the processor is configured to convert information about changed text into a bitmap image.

4. The server device of claim 3, wherein the processor is configured to divide the bitmap image into syllable units to generate at least one object.

5. The server device of claim 4, wherein the processor is configured to control the communication circuitry to transmit the at least one object to the controller.

6. A home appliance management system comprising:
a controller configured to control a home appliance;
a user terminal device configured to receive a user input; and
a server device configured to communicate with the controller and the user terminal device,
wherein the server device is configured to convert user interface information into an image based on the user input which is received from the user terminal device, and control a communication circuitry to transmit the image to the controller.

7. The home appliance management system of claim 6, wherein the user terminal device is configured to display an input screen,
wherein the input screen is configured to receive changes inputted to the user interface information from a user.

8. The home appliance management system of claim 6, wherein the user terminal device displays changes inputted in an input screen of the user terminal device to be overlaid on the user interface information that is a target of the changes.

9. The home appliance management system of claim 6, wherein the controller is configured to display an input screen,
wherein the input screen is configured to receive a selection in association with the image from a user.

10. The home appliance management system of claim 9, wherein the controller is configured to, based on an image displayed on the input screen according to the selection by the user, change text information in the user interface information.

11. A service device control method comprising:
receiving user interface information from a controller;
transmitting the user interface information to a user terminal device;
converting the user interface information into an image based on an user input received from the user terminal device; and
transmitting the image to the controller.

12. The service device control method of claim 11, wherein the user input is an input from a user enabling text information in the user interface information to be changed.

13. The service device control method of claim 12, further comprising converting the changed text information into a bitmap image.

14. The service device control method of claim 13, further comprising dividing the bitmap image into syllable units to generate at least one object.

15. The service device control method of claim 14, further comprising transmitting the at least one object to the controller.
